(19) United States
(12) Patent Application Publication
(10) Pub. No.: US 2024/0410783 A1
(43) Pub. Date: Dec. 12, 2024

(54) MEASUREMENT SYSTEM AND MEASUREMENT METHOD FOR MEASURING CHIP-SCALE POLARIZING PLATES

(71) Applicants: AimCore Technology Co., Ltd., Hsin Chu Industrial Park (TW); Minghsin University of Science and Technology, Xinfeng Township (TW)

(72) Inventors: Wein-Kuen Hwang, Fuxing Township (TW); Bing-Mau Chen, Xinfeng Hsinchu (TW); Shang-Ping YING, Xinfeng Hsinchu (TW)

(73) Assignees: AimCore Technology Co., Ltd., Hsin Chu Industrial Park (TW); Minghsin University of Science and Technology, Xinfeng Township (TW)

(21) Appl. No.: 18/208,071

(22) Filed: Jun. 9, 2023

(51) Int. Cl. G01M 11/02

(52) U.S. Cl. CPC G01M 11/0285

(57) ABSTRACT

Disclosed a measurement system for measuring chip-scale polarizing plates, which projects incident lights respectively having a first polarization direction and a second polarization direction to a plurality of chip-scale polarizing plates on a tested wafer, and uses the intensities of the penetrating lights passing through the chip-scale polarizing plates to calculate the transmittances and extinction ratios of the chip-scale polarizing plates so as to determine whether one or more of the chip-scale polarizing plates are unqualified products, wherein the first polarization direction is perpendicular to the second polarization direction; the first polarization direction is perpendicular or parallel to the polarization direction of the chip-scale polarizing plates. The measurement system and measurement method of the present invention can simultaneously measure a plurality of chip-scale polarizing plates and thus can increase the productivity of chip-scale polarizing plates.

### BACKGROUND OF THE INVENTION

### Field of the Invention

The present invention relates to a measurement system and a measurement method for measuring polarizing plates, particularly for measuring chip-scale polarizing plates.

### Description of the Prior Art

Polarizing plates are optical elements allowing only the light having a specified polarization direction to pass. The polarizing plates were mainly used to assist display devices in presenting images. However, the polarizing plates have been widely applied to other optical devices recently, such as ambient light sensors (ALS), proximity sensors (PS), fingerprint recognition devices, 3D facial recognition devices, and high-end projector systems.

Ambient light sensors (ALS), proximity sensors (PS), fingerprint recognition devices, and 3D facial recognition devices almost have been the indispensable components for smartphones. In order to increase the accuracy of sensation, some manufacturers have applied polarizing plates to the abovementioned devices to enhance the contrast of images or decrease the external interference. The sizes of ambient light sensors, proximity sensors, fingerprint recognition devices, and 3D facial recognition devices, which are used in mobile phones, are very small. Therefore, only the chip-scale (about 1-1,000 um) polarizing plates can be used in these devices. Considering the fabrication process and cost, some manufacturers expect that the polarizing plates can be sold in the form of chips, so that the polarizing plates can be installed in these devices in a plug-in way.

The current method for measuring polarizing plates can only measure the polarizing plates one by one. While the polarizing plates are reduced to the chip scale, numerous chip-scale polarizing plates are formed on a piece of wafer. Thus, much time will be spent in measuring chip-scale polarizing plates to determine whether they are qualified. For example, a 4-in. wafer may be cut into about 10,000 pieces of 500 um×500 um chips. If they are measured in the current method one by one, it would take about one day. However, a production line may output 1,000 wafers in one day. Therefore, the current measurement method greatly constrains the productivity of chip-scale polarizing plates.

### SUMMARY OF THE INVENTION

One objective of the present invention is to provide a measurement system and a measurement method for measuring chip-scale polarizing plates.

Another objective of the present invention is to provide a measurement system and a measurement method, which can increase the productivity of measuring chip-scale polarizing plates.

According to one embodiment of the present invention, the measurement system for measuring chip-scale polarizing plates comprises a light projecting device, a fixing mechanism, a light sensing device, and a processor. The light projecting device provides an incident light having a polarization direction, wherein the light projecting device can control the polarization direction. The fixing mechanism is disposed between the light projecting device and the light sensing device for fixing a tested wafer, wherein the incident light generates a penetrating light after passing through the tested wafer. The light sensing device obtains a light intensity distribution image according to the penetrating light. The processor is connected with the light sensing device and calculates the transmittances and the extinction ratios of the plurality of chip-scale polarizing plates on the wafer according to the light intensity distribution image. The processor determines whether one or more of the chip-scale polarizing plates are unqualified products according to the transmittances and the extinction ratios.

According to one embodiment of the present invention, the measurement method for measuring chip-scale polarizing plates comprises steps: projecting a first incident light having a first polarization direction onto a tested wafer, wherein the wafer has a plurality of chip-scale polarizing plates having the first polarization direction; obtaining a first light intensity distribution image according to a first penetrating light generated after the first incident light passes through the tested wafer; calculating a first transmittance of each of the chip-scale polarizing plates on the wafer according to the first light intensity distribution image; projecting a second incident light having a second polarization direction onto the tested wafer, wherein the second polarization direction is perpendicular to the first polarization direction; obtaining a second light intensity distribution image according to a second penetrating light generated after the second incident light passes through the tested wafer; calculating a second transmittance of each of the chip-scale polarizing plates on the wafer according to the second light intensity distribution image; calculating an extinction ratio of each of the chip-scale polarizing plates on the wafer according to the first transmittance and the second transmittance; and determining whether each of the chip-scale polarizing plates is an unqualified product according to the first transmittance and the extinction ratio.

### BRIEF DESCRIPTION OF THE DRAWINGS

FIG. 1 schematically shows a measurement system for measuring chip-scale polarizing plates according to one embodiment of the present invention.

FIG. 2 is a top view schematically showing a tested wafer.

FIG. 3 is an enlarged view of a local area in FIG. 2 and schematically shows a first embodiment of the chips.

FIG. 4 shows a flowchart of a measurement method for measuring chip-scale polarizing plates according to one embodiment of the present invention.

FIG. 5 schematically shows a second embodiment of the chips.

FIG. 6 schematically shows a third embodiment of the chips.

### DETAILED DESCRIPTION OF THE INVENTION

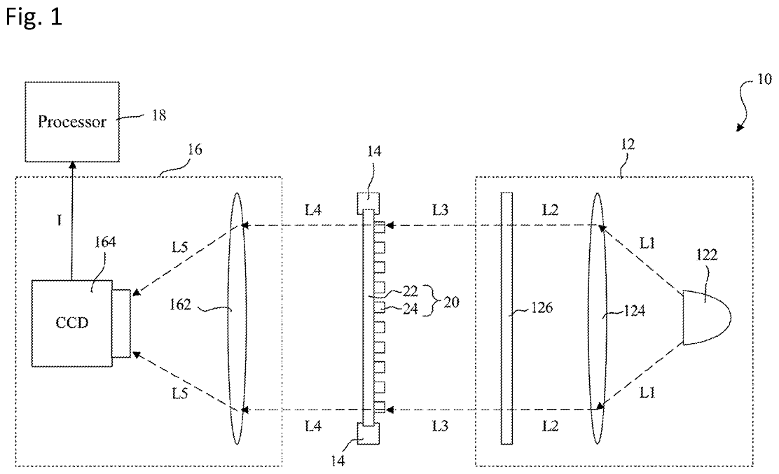

FIG. 1 schematically shows a measurement system for measuring chip-scale polarizing plates according to one embodiment of the present invention. In FIG. 1, the measurement system 10 of the present invention comprises a light projecting device 12, a fixing mechanism 14, a light sensing device 16, and a processor 18. The light projecting device 12 provides an incident light L3 having a polarization direction, wherein the light projecting device 12 can control the polarization direction of the incident light L3. In the embodiment shown in FIG. 1, the light projecting device 12 includes a light source 122, a collimating lens 124, and a standard polarizing plate 126. The collimating lens 124 is disposed between the light source 122 and the standard polarizing plate 126. The light source 122 provides a first light L1, which is non-polarized and projected onto the collimating lens 124. The collimating lens 124 collimates the first light L1 to generate a second light L2. The standard polarizing plate 126 filters the second light L2 to generate the incident light L3 having a polarization direction. The fixing mechanism 14 is disposed between the light projecting device 12 and the light sensing device 16 for fixing a tested wafer 20. The tested wafer 20 includes a transparent substrate 22 and a plurality of chip-scale polarizing plates 24. The incident light L3 provided by the light projecting device 12 projects onto and penetrates the tested wafer 20 to generate a penetrating light L4. The light sensing device 16 obtains a light intensity distribution image I according to the penetrating light L4. The light intensity distribution image I involves the intensity of the penetrating light of each of the chip-scale polarizing plates 24 on the tested wafer 20. The light sensing device 16 includes an imaging lens 162 and a charge-coupled device (CCD) 164. The imaging lens 162 is disposed between the fixing mechanism 14 (or the tested wafer 20) and the CCD 164 for focusing the penetrating light L4 to generate focused light L5. The CCD 164 obtains the light intensity distribution image I according to the focused light L5 coming from the imaging lens 162. The processor 18 is connected with the light sensing device 16 and calculates the transmittance and the extinction ratio of each of the chip-scale polarizing plates 24 on the tested wafer 20 according to the light intensity distribution image I provided by the light sensing device 16. In one embodiment, the processor 18 uses an image analyzing program to calculate the transmittances and the extinction ratios of the chip-scale polarizing plates 24. The image analyzing program may be but is not limited to the Labview or may include the Labview.

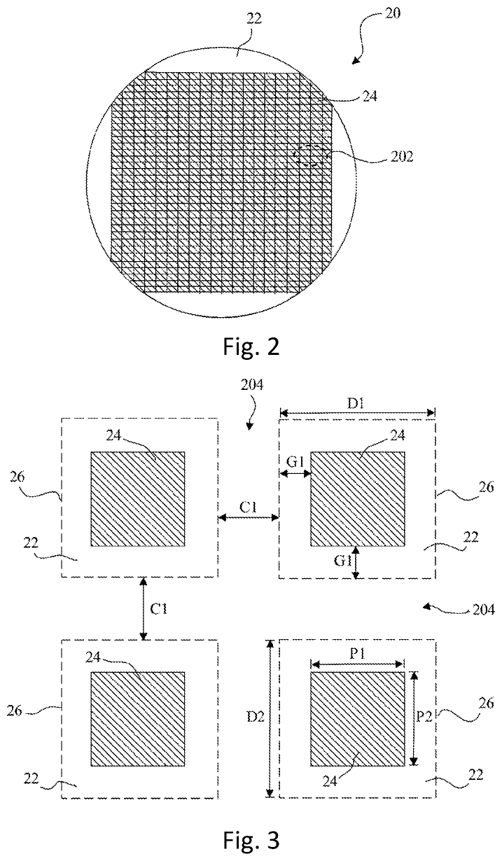

FIG. 2 is a top view schematically showing the tested wafer 20. FIG. 3 is an enlarged view of a local area 202 in FIG. 2 and schematically shows a first embodiment of the chips. In FIG. 2 and FIG. 3, the tested wafer 20 may be diced into a plurality of chips 26, each having a chip-scale polarizing plate 24. A cutting channel 204 exists between the chips 26 and has a width C1. The chip 26 has a length D1 and a width D2. The chip-scale polarizing plate 24 has a length P1 and a width P2. A gap G1 exists between the border of the chip-scale polarizing plate 24 and the border of the chip 26. In one embodiment, the width C1 is about 30-300 um; the length D1 and the width D2 is about 21-1,400 um; the length P1 and the width P2 is about 1-1,000 um; the gap G1 is about 10-100 um. However, the present invention is not limited by the abovementioned embodiment.

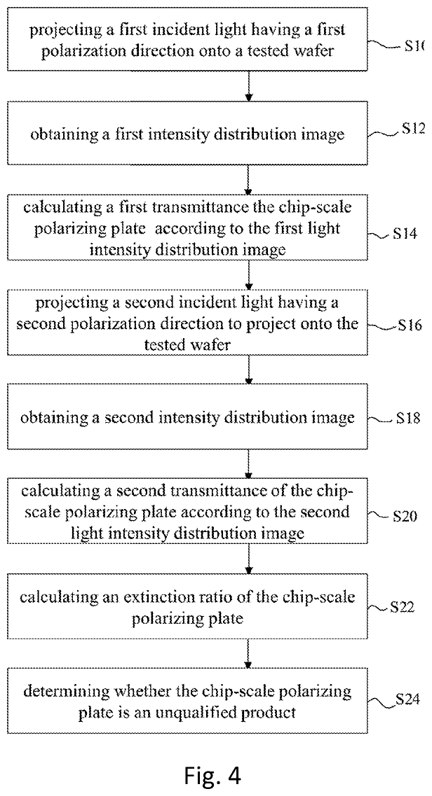

FIG. 4 is a flowchart of a measurement method for measuring chip-scale polarizing plates according to one embodiment of the present invention. Refer to FIGS. 1-4. In FIG. 2 and FIG. 3, the chip-scale polarizing plate 24 has a polarization direction of −45 degrees. Therefore, the standard polarizing plate 126 of the light projecting device 12 is adjusted to have a polarization direction of −45 degrees also. Thereby, the light projecting device 12 projects an incident light L3 having a polarization direction of −45 degrees to illuminate the tested wafer 20, as stated in Step S10. Next, the process proceeds to Step S12. In Step S12, after the incident light L3 passes through the wafer 20, the penetrating light L4 is generated; the imaging lens 162 focuses the penetrating light L4 to generate a focused light L5; the CCD 164 obtains the light intensity distribution image I. Next, the process proceeds to Step S14. In step S14, after obtaining the light intensity distribution image I, the processor 18 works out a first transmittance T1=L4/L3 of each chip-scale polarizing plate 24 based on the light intensity at the position corresponding to each chip-scale polarizing plate 24 according to the light intensity distribution image I. Next, the process proceeds to Step S16. In step S16, after the first transmittance T1 is obtained, the standard polarizing plate 126 is adjusted to have a polarization direction of +45 degrees (i.e., perpendicular to the polarization direction of the chip-scale polarizing plate 24) to generate an incident light L3′ (not shown in the drawings) having a polarization direction of +45 degrees for illuminating the tested wafer 20. Next, the process proceeds to Step S18. In step S18, the incident light L3′ passes through the tested wafer 20 to generate a penetrating light L4′ (not shown in the drawings); the imaging lens 162 focuses the penetrating light L4′ to generate a focused light L5; the CCD 164 obtains a light intensity distribution image I′ (not shown in the drawings) according to the focused light L5. Next, the process proceeds to Step S20. In step S20, the processor 18 works out a second transmittance T2=L4′/L3′ of each chip-scale polarizing plate 24 according to the light intensity at the position corresponding to each chip-scale polarizing plate 24 according to the light intensity distribution image I′. Next, the process proceeds to Step S22. In step S22, after obtaining the first transmittance T1 and the second transmittance T2 of each chip-scale polarizing plate 24, the processor 18 works out an extinction ratio E=T1/T2 of each chip-scale polarizing plate 24. Then, the process proceeds to Step S24. In step S24, the processor 18 determines whether one chip-scale polarizing plate 24 is an unqualified product according to the first transmittance T1 and extinction ratio E thereof.

In one embodiment, the measurement method of the present invention can measure all the chip-scale polarizing plates 24 on the tested wafer 20 in a single measurement. Alternatively, the measurement method of the present invention divides the tested wafer 20 into a plurality of blocks and measures the blocks in sequence. Therefore, the measurement method of the present invention can measure a great number of chip-scale polarizing plates 24 in a single measurement. Thus, the present invention can obviously reduce the total time spent in measuring a tested wafer 20. Then, the present invention can raise the productivity of the chip-scale polarizing plates 24.

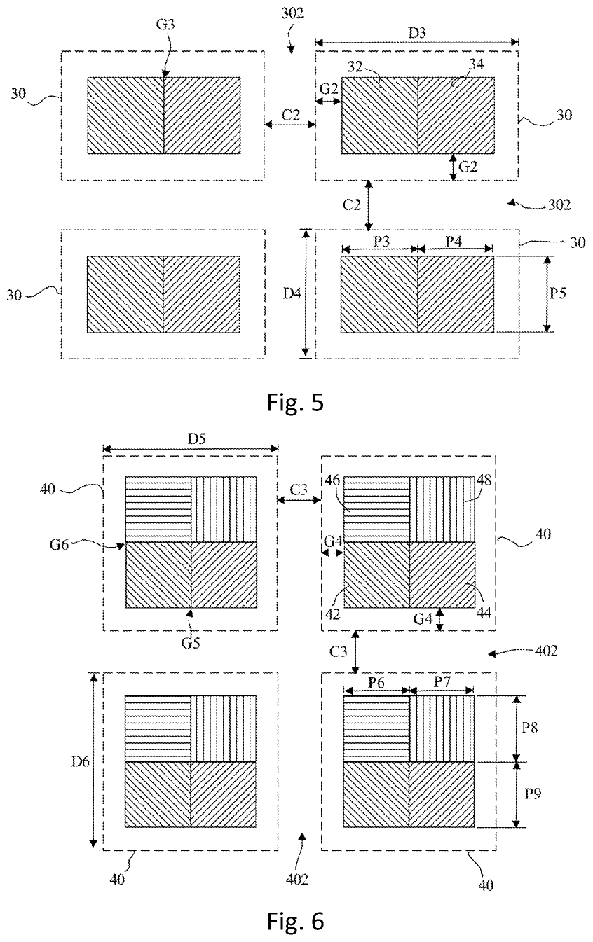

In the embodiment shown in FIG. 2 and FIG. 3, all the chip-scale polarizing plates 24 on the tested wafer 20 have the same polarization direction. However, the chip-scale polarizing plates of the tested wafer 20 may have different polarization directions in other embodiments. FIG. 5 schematically shows a second embodiment of the chips. In FIG. 5, a chip 30 has two chip-scale polarizing plates 32 and 34 respectively having different polarization directions. The chip-scale polarizing plate 32 has a polarization direction of −45 degrees; the chip-scale polarizing plate 34 has a polarization direction of +45 degrees. The polarization direction of the chip-scale polarizing plate 32 is perpendicular to the polarization direction of the chip-scale polarizing plate 34. A cutting channel 302 exists between the chips 30. The cutting channel 302 has a width C2. The chip 30 has a length D3 and a width D4. The chip-scale polarizing plate 32 has a length P3 and a width P5. The chip-scale polarizing plate 34 has a length P4 and a width P5. A gap G2 exists between the border of the chip-scale polarizing plate 32/34 and the border of the chip 30. A gap G3 exists between the chip-scale polarizing plates 32 and 34. In one embodiment, the width C2 is about 30-300 um; the length D3 is about 22-2,500 um; the width D4 is about 21-1,400 um; the length P3 is about 1-1,000 um; the width P4 is about 1-1,000 um; the width P5 is about 1-1,000 um; the gap G2 is about 10-200 um; the gap G3 is about 0-100 um. However, the present invention is not limited by the abovementioned embodiment.

The measurement method for the chips 30 in FIG. 5 is shown in FIG. 4. Refer to FIG. 1, FIG. 4, and FIG. 5. Firstly, in Step S10, adjust the standard polarizing plate 126 of the light projecting device 12 to have a polarization direction of −45 degrees (i.e. parallel to the polarization direction of the chip-scale polarizing plate 32 and perpendicular to the chip-scale polarizing plate 34) to let the light projecting device 12 projects an incident light L3 having a polarization direction of −45 degrees onto the tested wafer 20. Next, the process proceeds to Step S12. In Step S12, the incident light L3 passes through the tested wafer 20 to generate the penetrating light L4; the light sensing device 16 obtains the light intensity distribution image I. Next, the process proceeds to Step S14. In Step S14, after obtaining the light intensity distribution image I, the processor 18 works out a first transmittance T1=L4/L3 of each chip-scale polarizing plate 32/34 based on the light intensity at the position corresponding to each chip-scale polarizing plate 32/34 according to the light intensity distribution image I. Next, the process proceeds to Step S16. In step S16, after the first transmittance T1 is obtained, the standard polarizing plate 126 is adjusted to have a polarization direction of +45 degrees (i.e., perpendicular to the polarization direction of the chip-scale polarizing plate 32 and parallel to the chip-scale polarizing plate 34) to generate an incident light L3′ (not shown in the drawings) having a polarization direction of +45 degrees for illuminating the tested wafer 20. Next, the process proceeds to Step S18. In step S18, the incident light L3′ passes through the tested wafer 20 to generate a penetrating light L4′ (not shown in the drawings); the light sensing device 16 obtains a light intensity distribution image I′ (not shown in the drawings) according to the penetrating light L4′. Next, the process proceeds to Step S20. In step S20, the processor 18 works out a second transmittance T2=L4′/L3′ of each chip-scale polarizing plate 32/34 according to the light intensity at the position corresponding to each chip-scale polarizing plate 32/34 according to the light intensity distribution image I′. Next, the process proceeds to Step S22. In step S22, after obtaining the first transmittance T1 and the second transmittance T2 of each chip-scale polarizing plate 32/34, the processor 18 works out an extinction ratio E1=T1/T2 of each chip-scale polarizing plate 32 and an extinction ratio E2=T2/T1 of each chip-scale polarizing plate 34. Then, the process proceeds to Step S24. In step S24, the processor 18 determines whether one chip-scale polarizing plate 32 is an unqualified product according to the first transmittance T1 and extinction ratio E1 thereof and determines whether one chip-scale polarizing plate 34 is an unqualified product according to the second transmittance T2 and extinction ratio E2 thereof.

FIG. 6 schematically shows a third embodiment of the chips. In FIG. 6, a chip 40 has four chip-scale polarizing plates 42, 44, 46, and 48 respectively having different polarization directions. The chip-scale polarizing plate 42 has a polarization direction of −45 degrees; the chip-scale polarizing plate 44 has a polarization direction of +45 degrees; the chip-scale polarizing plate 46 has a polarization direction of 0 degrees (the horizontal polarization direction); the chip-scale polarizing plate 48 has a polarization direction of 90 degrees (the perpendicular polarization direction). The polarization direction of the chip-scale polarizing plate 42 is perpendicular to the polarization direction of the chip-scale polarizing plate 44. The polarization direction of the chip-scale polarizing plate 46 is perpendicular to the polarization direction of the chip-scale polarizing plate 48. A cutting channel 402 exists between the chips 40. The cutting channel 402 has a width C3. The chip 40 has a length D5 and a width D6. The chip-scale polarizing plate 42 has a length P6 and a width P9. The chip-scale polarizing plate 44 has a length P7 and a width P9. The chip-scale polarizing plate 46 has a length P6 and a width P8. The chip-scale polarizing plate 48 has a length P7 and a width P8. A gap G4 exists between the border of the chip 40 and the border of the chip-scale polarizing plates 42, 44, 46 and 48. A gap G5 exists between the border of the chip-scale polarizing plates 42 and the border of the chip-scale polarizing plate 44. A gap G5 exists between the border of the chip-scale polarizing plates 46 and the border of the chip-scale polarizing plate 48. A gap G6 exists between the border of the chip-scale polarizing plates 42 and the border of the chip-scale polarizing plate 46. A gap G6 exists between the border of the chip-scale polarizing plates 44 and the border of the chip-scale polarizing plate 48. In one embodiment, the width C3 is about 30-300 um; the length D5 is about 33-25,000 um; the width D6 is about 22-2,500 um; the length P6 is about 1-1,000 um; the length P7 is about 1-1,000 um; the width P8 is about 1-1,000 um; the length P9 is about 1-1000 um; the gap G4 is about 10-200 um; the gap G5 is about 0-100 um; the gap G6 is about 0-100 um. However, the present invention is not limited by the abovementioned embodiment.

The measurement method for the chips 40 in FIG. 6 is shown in FIG. 4. The measurement steps of the chip-scale polarizing plates 42 and 44 shown in FIG. 6 is the same as that of the chip-scale polarizing plates 32 and 34 shown in FIG. 5 and will not repeat herein. After determining whether the chip-scale polarizing plates 42 and 44 are unqualified products, the process returns to Step S10, and the polarization direction of the standard polarizing plate 126 of the light projecting device 12 is adjusted to have a horizontal direction. In other words, the polarization direction of the standard polarizing plate 126 is parallel to the polarization direction of the chip-scale polarizing plates 46 and perpendicular to the polarization direction of the chip-scale polarizing plates 48 to make the light projecting device 12 projects an incident light L3″ (not shown in the drawings) onto the tested wafer 20. Next, the process proceeds to Step S12. In Step S12, the incident light L3″ passes through the tested wafer 20 to generate a penetrating light L4″ (not shown in the drawings); the light sensing device 16 obtains an light intensity distribution image I″ according to the penetrating light L4″ (not shown in the drawings). Next, the process proceeds to Step S14. In Step S14, after obtaining the light intensity distribution image I″, the processor 18 works out a first transmittance T1′=L4″/L3″ of each chip-scale polarizing plate 46/48 based on the light intensity at the position corresponding to each chip-scale polarizing plate 46/48 according to the light intensity distribution image I″. Next, the process proceeds to Step S16. In Step S16, after the first penetrating rate T1″ is obtained, the standard polarizing plate 126 is adjusted to have a perpendicular polarization direction so as to generate an incident light L3″ (not shown in the drawings) having a perpendicular polarization direction to illuminate the tested wafer 20, wherein the perpendicular polarization direction is perpendicular to the polarization direction of the chip-scale polarizing plate 46 and parallel to the polarization direction of the chip-scale polarizing plate 48. Next, the process proceeds to Step S18. In Step S18, an incident light L3′″ passes through the tested wafer 20 to generate a penetrating light L4′″ (not shown in the drawings); the light sensing device 16 obtains a light intensity distribution image I″ (not shown in the drawings) according to the penetrating light L4″. Next, the process proceeds to Step S20. In Step S20, the processor 18 works out a second transmittance T2′=L4″/L3′″ of each chip-scale polarizing plate 46/48 based on the light intensity at the position corresponding to each chip-scale polarizing plate 46/48 according to the light intensity distribution image I′″. Next, the process proceeds to Step S22. In Step S22, after obtaining the first transmittance T1′ and the second transmittance T2′ of each chip-scale polarizing plate 46/48, the processor 18 works out an extinction ratio E1′=T1′/T2′of each chip-scale polarizing plate 46 and an extinction ratio E2′=T2′/T1′ of each chip-scale polarizing plate 48. Then, the process proceeds to Step S24. In step S24, the processor 18 determines whether one chip-scale polarizing plate 46 is an unqualified product according to the first transmittance T1′ and extinction ratio E1′ thereof and determines whether one chip-scale polarizing plate 48 is an unqualified product according to the second transmittance T2′ and extinction ratio E2′ thereof.

In the measurement method for the chips in FIG. 6, while measuring the chip-scale polarizing plates 42 and 44, the processor 18 may neglect the light intensities at the positions corresponding to the chip-scale polarizing plates 46 and 48. Similarly, while measuring the chip-scale polarizing plates 46 and 48, the processor 18 may neglect the light intensities at the positions corresponding to the chip-scale polarizing plates 42 and 44.

In the embodiments shown in FIG. 3, FIG. 5, and FIG. 6, the chips 26, 30 and 40 have a shape of a square or a rectangle. However, the present invention is not limited by these embodiments. In other embodiments, the chips 26, 30 and 40 have a regular shape or an irregular shape, such as a rhombus shape, a quadrilateral shape, a pentagonal shape, or a hexagonal shape.

The embodiments described above are only to exemplify the present invention but not to limit the scope of the present invention. Equivalent modifications or variations of these embodiments may be made by the persons having ordinary knowledge of the art according to the technical contents of the present invention without departing from the scope of the present invention and would be included by the scope of the present invention.

What is claimed is:

1. A measurement system for measuring a plurality of chip-scale polarizing plates, the measurement system comprising:
a light projecting device providing an incident light having a polarization direction, wherein the light projecting device can control the polarization direction;
a light sensing device obtaining a light intensity distribution image according to a penetrating light;
a fixing mechanism disposed between the light projecting device and the light sensing device and configured to fix a tested wafer, wherein the penetrating light is generated while the incident light passes through the tested wafer; and
a processor connected with the light sensing device and calculating transmittances and extinction ratios of the plurality of chip-scale polarizing plates on the tested wafer according to the light intensity distribution image.

2. The measurement system according to claim 1, wherein the light projecting device comprises:
a light source configured to provide a first light which is non-polarized;
a standard polarizing plate configured to filter a second light to generate the incident light having the polarization direction; and
a collimating lens disposed between the light source and the standard polarizing plate and configured to collimate the first light to generate the second light,
wherein the polarization direction is changed by the standard polarizing plate.

3. The measurement system according to claim 1, wherein the light sensing device comprises:
a charge-coupled device obtaining the light intensity distribution image according to a focused light; and
an imaging lens disposed between the fixing mechanism and the charge-coupled device and configured to focus the penetrating light to generate the focused light.

4. The measurement system according to claim 1, wherein the processor configured to calculate the transmittances and the extinction ratios by an image analyzing program.

5. The measurement system according to claim 1, wherein the image analyzing program comprises Labview.

6. A measurement method for measuring a plurality of chip-scale polarizing plates, the measurement method comprising steps:
Step A: projecting a first incident light having a first polarization direction onto a tested wafer, wherein the tested wafer has the plurality of chip-scale polarizing plates having the first polarization direction;
Step B: obtaining a first light intensity distribution image according to a first penetrating light generated after the first incident light passes through the tested wafer;
Step C: calculating a first transmittance of each of the chip-scale polarizing plates on the tested wafer according to the first light intensity distribution image;
Step D: projecting a second incident light having a second polarization direction onto the tested wafer, wherein the second polarization direction is perpendicular to the first polarization direction;
Step E: obtaining a second light intensity distribution image according to a second penetrating light generated after the second incident light passes through the tested wafer;
Step F: calculating a second transmittance of each of the chip-scale polarizing plates on the tested wafer according to the second light intensity distribution image;
Step G: calculating an extinction ratio of each of the chip-scale polarizing plates on the tested wafer according to the first transmittance and the second transmittance; and
Step H: determining whether each of the chip-scale polarizing plates is an unqualified product according to the first transmittance and the extinction ratio.

7. The measurement method according to claim 6, wherein a charge-coupled device is configured to obtain the first light intensity distribution image and the second light intensity distribution image in Step B and Step E, respectively.

8. The measurement method according to claim 6, wherein an image analyzing program is configured to respectively obtain the first transmittance, the second transmittance, and the extinction ratio in Step C, Step F, and Step G.

9. The measurement method according to claim 8, wherein the image analyzing program comprises Labview.
